(19) United States
(12) Patent Application Publication
(10) Pub. No.: US 2023/0011187 A1
(43) Pub. Date: Jan. 12, 2023

(54) DYNAMIC COMPENSATION OF POWER SUPPLY VOLTAGES FOR DIFFERENT SECTIONS OF DISPLAY AREA

(71) Applicant: Meta Platforms Technologies, LLC, Menlo Park, CA (US)

(72) Inventors: Wenhao Qiao, Milpitas, CA (US); Donghee Nam, San Jose, CA (US); Alexander Klement, Kenmore, WA (US); Min Hyuk Choi, San Jose, CA (US)

(21) Appl. No.: 17/371,892

(22) Filed: Jul. 9, 2021

(51) Int. Cl. G09G 3/3258; G09G 3/3291; G02B 27/01

(52) U.S. Cl. CPC G09G 3/3258; G09G 3/3291; G02B 27/0172; G09G 2330/021; G09G 2330/028; G09G 2320/0686; G02B 2027/0178

(57) ABSTRACT

Embodiments relate to a display device including two or more sections of pixels in a display area powered by supply voltages in power rails. The display device also includes two or more power detection circuits connected to two or more locations along the power rails to detect local voltages at the locations. Depending on an image being display during a frame, the two or more sections of pixels may cause changes in local voltages at the two or more locations. The detected local voltages are provided to two or more voltage regulators, and the two or more voltage regulators update supply voltages provided to the power rails to compensate for the changes in the local voltages.

### BACKGROUND

This disclosure relates to a display device, and specifically to sensing local voltages at locations along power rails that provide supply voltages to a plurality of sections of pixels in the display device and compensating for changes in the local voltages.

A display device is often used in a virtual reality (VR) or augmented-reality (AR) system as a head-mounted display (HMD) or a near-eye display (NED). The display device may include an array of OLED pixels that emits light. To display a high-resolution image, the display device may include a large number of pixels in the array that are operated at a high frame rate. Depending on the image being displayed by the pixels, there can be a higher voltage drop at a segment of power rail that provides a supply voltage to one section of pixels compared to another segment of power rail that provides the supply voltage to another section of pixels. As a result of varying current demand in different sections of pixels, supply voltages at different segments of the power rails may be lower or higher than the desired supply voltages. The inconsistent voltage drops along the power rails may lead to lower quality images, which degrades user experiences.

### SUMMARY

Embodiments relate to a display device including a display panel and two or more voltage regulator connected to the display panel. The display panel includes two or more sections of pixels, power rails, and two or more power detection circuits. The power rails provide supply voltages to operate the sections of pixels. The power detection circuits are connected to corresponding locations of the power rails to detect local voltages at the locations. The voltage regulators generate the supply voltages to be provided to the power rails of the display panel for operating the sections of pixels. The voltage regulators generate the supply voltages to compensate for changes in local voltages in the local voltages as detected by the two or more power detection circuits.

### BRIEF DESCRIPTION OF DRAWINGS

FIG. 1 is a diagram of a head-mounted display (HMD) that includes a near-eye display (NED), according to some embodiments.

FIG. 2 is a cross-sectional view of the HMD illustrated in FIG. 1, according to some embodiments.

FIG. 3 illustrates a perspective view of a waveguide display, according to some embodiments.

FIG. 4 depicts a simplified organic light-emitting diode (OLED) structure, according to some embodiments.

FIG. 5 is a schematic view of an OLED display device architecture including a display driver integrated circuit (DDIC), according to some embodiments.

FIG. 6 is a schematic view of an OLED display device, according to some embodiments.

FIG. 7 is a circuit diagram of an OLED pixel, according to some embodiments.

FIG. 8 depicts an example image displayed by an OLED display device, according to some embodiments.

FIGS. 9A-9C illustrate schematic views of supply voltage compensation of an OLED display device, according to some embodiments.

FIG. 10 is a flowchart illustrating supply voltage compensation of an OLED display device, according to some embodiments.

The figures depict embodiments of the present disclosure for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### Near-Eye Display

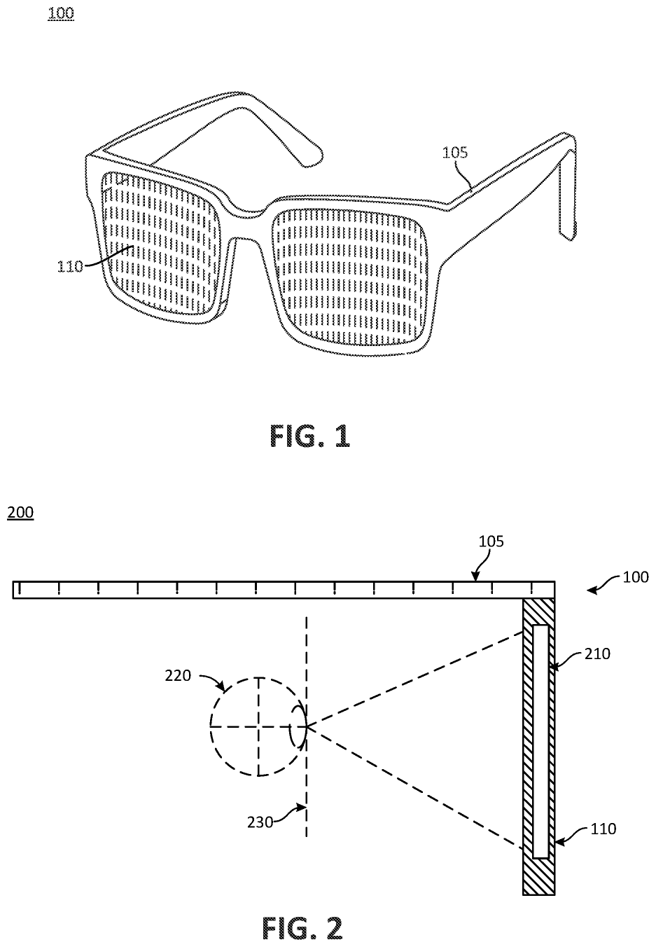

FIG. 1 is a diagram of a near-eye-display (NED) 100, in accordance with some embodiments. The NED 100 may present media to a user. Examples of media that may be presented by the NED 100 include one or more images, video, audio, or some combination thereof. In some embodiments, audio may be presented via an external device (e.g., speakers and/or headphones) that receives audio information from the NED 100, a console (not shown), or both, and presents audio data to the user based on the audio information. The NED 100 is generally configured to operate as a virtual reality (VR) NED. However, in some embodiments, the NED 100 may be modified to also operate as an augmented reality (AR) NED, a mixed reality (MR) NED, or some combination thereof. For example, in some embodiments, the NED 100 may augment views of a physical, real-world environment with computer-generated elements (e.g., still images, video, sound, etc.).

The NED 100 shown in FIG. 1 may include a frame 105 and a display 110. The frame 105 may include one or more optical elements that together display media to a user. That is, the display 110 may be configured for a user to view the content presented by the NED 100. As discussed below in conjunction with FIG. 2, the display 110 may include at least one source assembly to generate image light to present optical media to an eye of the user. The source assembly may include, e.g., a source, an optics system, or some combination thereof.

FIG. 1 is merely an example of a virtual reality system, and the display systems described herein may be incorporated into further such systems. In some embodiments, FIG. 1 may also be referred to as a Head-Mounted-Display (HMD).

FIG. 2 is a cross section 200 of the NED 100 illustrated in FIG. 1, in accordance with some embodiments of the present disclosure. The cross section 200 may include at least one display assembly 210, and an exit pupil 230. The exit pupil 230 is a location where the eye 220 may be positioned when the user wears the NED 100. In some embodiments, the frame 105 may represent a frame of eye-wear glasses. For purposes of illustration, FIG. 2 shows the cross section 200 associated with a single eye 220 and a single display assembly 210, but in alternative embodiments not shown, another display assembly that is separate from or integrated with the display assembly 210 shown in FIG. 2, may provide image light to another eye of the user.

The display assembly 210 may direct the image light to the eye 220 through the exit pupil 230. The display assembly 210 may be composed of one or more materials (e.g., plastic, glass, etc.) with one or more refractive indices that effectively decrease the weight and widen a field of view of the NED 100.

In alternate configurations, the NED 100 may include one or more optical elements (not shown) between the display assembly 210 and the eye 220. The optical elements may act to, by way of various examples, correct aberrations in image light emitted from the display assembly 210, magnify image light emitted from the display assembly 210, perform some other optical adjustment of image light emitted from the display assembly 210, or combinations thereof. Example optical elements may include an aperture, a Fresnel lens, a convex lens, a concave lens, a filter, or any other suitable optical element that may affect image light.

In some embodiments, the display assembly 210 may include a source assembly to generate image light to present media to a user's eyes. The source assembly may include, e.g., a light source, an optics system, or some combination thereof. In accordance with various embodiments, a source assembly may include a light-emitting diode (LED) such as an organic light-emitting diode (OLED).

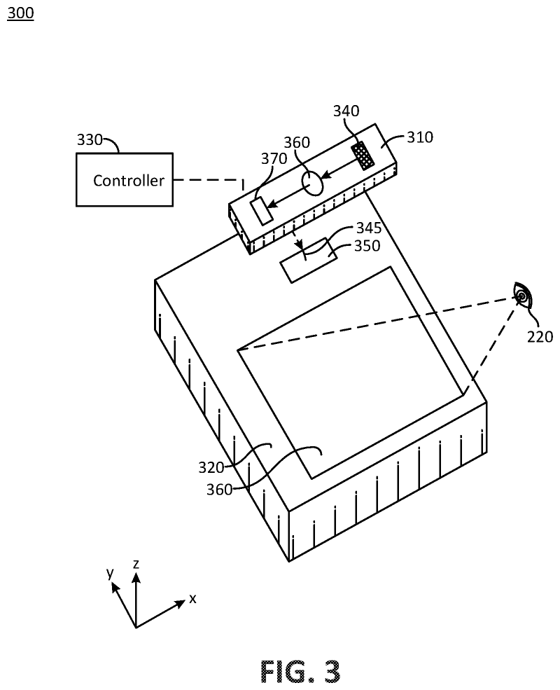

FIG. 3 illustrates a perspective view of a waveguide display 300 in accordance with some embodiments. The waveguide display 300 may be a component (e.g., display assembly 210) of NED 100. In alternate embodiments, the waveguide display 300 may constitute a part of some other NED, or other system that directs display image light to a particular location.

The waveguide display 300 may include, among other components, a source assembly 310, an output waveguide 320, and a controller 330. For purposes of illustration, FIG. 3 shows the waveguide display 300 associated with a single eye 220, but in some embodiments, another waveguide display separate (or partially separate) from the waveguide display 300 may provide image light to another eye of the user. In a partially separate system, for instance, one or more components may be shared between waveguide displays for each eye.

The source assembly 310 generates image light. The source assembly 310 may include a source 340, a light conditioning assembly 360, and a scanning mirror assembly 370. The source assembly 310 may generate and output image light 345 to a coupling element 350 of the output waveguide 320.

The source 340 may include a source of light that generates at least a coherent or partially coherent image light 345. The source 340 may emit light in accordance with one or more illumination parameters received from the controller 330. The source 340 may include one or more source elements, including, but not restricted to light emitting diodes, such as micro-OLED s.

The output waveguide 320 may be configured as an optical waveguide that outputs image light to an eye 220 of a user. The output waveguide 320 receives the image light 345 through one or more coupling elements 350 and guides the received input image light 345 to one or more decoupling elements 360. In some embodiments, the coupling element 350 couples the image light 345 from the source assembly 310 into the output waveguide 320. The coupling element 350 may be or include a diffraction grating, a holographic grating, some other element that couples the image light 345 into the output waveguide 320, or some combination thereof. For example, in embodiments where the coupling element 350 is a diffraction grating, the pitch of the diffraction grating may be chosen such that total internal reflection occurs, and the image light 345 propagates internally toward the decoupling element 360. For example, the pitch of the diffraction grating may be in the range of approximately 300 nm to approximately 600 nm.

The decoupling element 360 decouples the total internally reflected image light from the output waveguide 320. The decoupling element 360 may be or include a diffraction grating, a holographic grating, some other element that decouples image light out of the output waveguide 320, or some combination thereof. For example, in embodiments where the decoupling element 360 is a diffraction grating, the pitch of the diffraction grating may be chosen to cause incident image light to exit the output waveguide 320. An orientation and position of the image light exiting from the output waveguide 320 may be controlled by changing an orientation and position of the image light 345 entering the coupling element 350.

The output waveguide 320 may be composed of one or more materials that facilitate total internal reflection of the image light 345. The output waveguide 320 may be composed of, for example, silicon, glass, or a polymer, or some combination thereof. The output waveguide 320 may have a relatively small form factor such as for use in a head-mounted display. For example, the output waveguide 320 may be approximately 30 mm wide along an x-dimension, 50 mm long along a y-dimension, and 0.5-1 mm thick along a z-dimension. In some embodiments, the output waveguide 320 may be a planar (2D) optical waveguide.

The controller 330 may be used to control the scanning operations of the source assembly 310. In certain embodiments, the controller 330 may determine scanning instructions for the source assembly 310 based at least on one or more display instructions. Display instructions may include instructions to render one or more images. In some embodiments, display instructions may include an image file (e.g., bitmap). The display instructions may be received from, e.g., a console of a virtual reality system (not shown). Scanning instructions may include instructions used by the source assembly 310 to generate image light 345. The scanning instructions may include, e.g., a type of a source of image light (e.g. monochromatic, polychromatic), a scanning rate, an orientation of scanning mirror assembly 370, and/or one or more illumination parameters, etc. The controller 330 may include a combination of hardware, software, and/or firmware not shown here so as not to obscure other aspects of the disclosure.

According to some embodiments, source 340 may include a light emitting diode (LED), such as an organic light emitting diode (OLED). An organic light-emitting diode (OLED) is a light-emitting diode (LED) having an emissive electroluminescent layer that may include a thin film of an organic compound that emits light in response to an electric current. The organic layer is typically situated between a pair of conductive electrodes. One or both of the electrodes may be transparent.

As will be appreciated, an OLED display can be driven with a passive-matrix (PMOLED) or active-matrix (AMOLED) control scheme. In a PMOLED scheme, each row (and line) in the display may be controlled sequentially, whereas AMOLED control typically uses a thin-film transistor backplane to directly access and switch each individual pixel on or off, which allows for higher resolution and larger display areas.

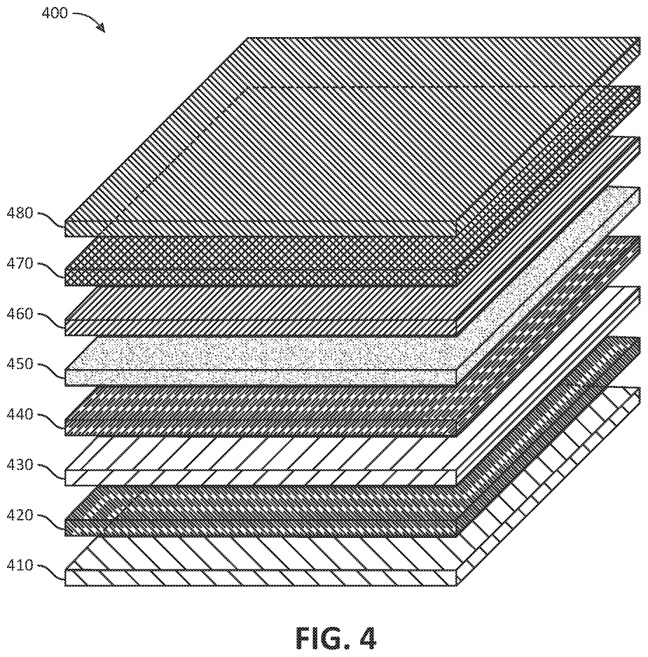

FIG. 4 depicts a simplified OLED structure 400 according to some embodiments. As shown in an exploded view, OLED 400 may include, from bottom to top, a substrate 410, anode 420, hole injection layer 430, hole transport layer 440, emissive layer 450, blocking layer 460, electron transport layer 470, and cathode 480. In some embodiments, substrate (or backplane) 410 may include single crystal or polycrystalline silicon or other suitable semiconductor (e.g., germanium).

Anode 420 and cathode 480 may include any suitable conductive material(s), such as transparent conductive oxides (TCOs, e.g., indium tin oxide (ITO), zinc oxide (ZnO), and the like). The anode 420 and cathode 480 are configured to inject holes and electrons, respectively, into one or more organic layer(s) within emissive layer 450 during operation of the device.

The hole injection layer 430, which is disposed over the anode 420, receives holes from the anode 420 and is configured to inject the holes deeper into the device, while the adjacent hole transport layer 440 may support the transport of holes to the emissive layer 450. The emissive layer 450 converts electrical energy to light. Emissive layer 450 may include one or more organic molecules, or light-emitting fluorescent dyes or dopants, which may be dispersed in a suitable matrix as known to those skilled in the art.

Blocking layer 460 may improve device function by confining electrons (charge carriers) to the emissive layer 450. Electron transport layer 470 may support the transport of electrons from the cathode 480 to the emissive layer 450.

In some embodiments, the generation of red, green, and blue light (to render full-color images) may include the formation of red, green, and blue OLED sub-pixels in each pixel of the display. Alternatively, the OLED 400 may be adapted to produce white light in each pixel. The white light may be passed through a color filter to produce red, green, and blue sub-pixels.

Any suitable deposition process(es) may be used to form OLED 400. For example, one or more of the layers constituting the OLED may be fabricated using physical vapor deposition (PVD), chemical vapor deposition (CVD), evaporation, spray-coating, spin-coating, atomic layer deposition (ALD), and the like. In further aspects, OLED 400 may be manufactured using a thermal evaporator, a sputtering system, printing, stamping, etc.

According to some embodiments, OLED 400 may be a micro-OLED. A “micro-OLED,” in accordance with various examples, may refer to a particular type of OLED having a small active light emitting area (e.g., less than 2,000 μm2 in some embodiments, less than 20 μm2 or less than 10 μm2 in other embodiments). In some embodiments, the emissive surface of the micro-OLED may have a diameter of less than approximately 2 μm. Such a micro-OLED may also have collimated light output, which may increase the brightness level of light emitted from the small active light emitting area.

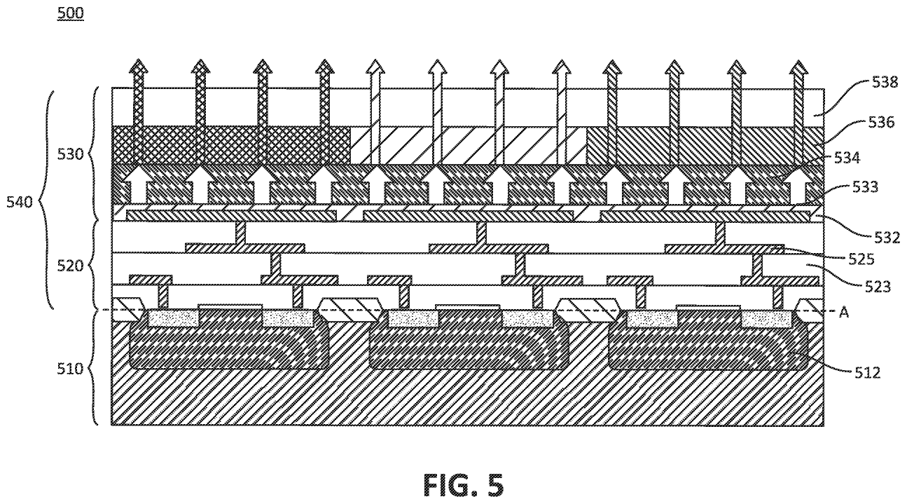

FIG. 5 is a schematic view of an OLED display device architecture including a display driver integrated circuit (DDIC) 510 according to some embodiments. According to some embodiments, OLED display device 500 (e.g., micro-OLED chip) may include a display active area 530 having an active matrix 532 (such as OLED 400) disposed over a single crystal (e.g., silicon) backplane 520. The combined display/backplane architecture, i.e., display panel 540 may be bonded (e.g., at or about interface A) directly or indirectly to the DDIC 510. As illustrated in FIG. 5, DDIC 510 may include an array of driving transistors 512, which may be formed using conventional CMOS processing. One or more display driver integrated circuits may be formed over a single crystal (e.g., silicon) substrate.

In some embodiments, the display active area 530 may have at least one areal dimension (i.e., length or width) greater than approximately 1.3 inches, e.g., approximately 1.4, 1.5, 1.6, 1.7, 1.8, 1.9, 2.0, 2.25, 2.5, 2.75, or 3 inches, including ranges between any of the foregoing values, although larger area displays are contemplated.

Backplane 520 may include a single crystal or polycrystalline silicon layer 523 having a through silicon via 525 for electrically connecting the DDIC 510 with the display active area 530. In some embodiments, display active area 530 may further include a transparent encapsulation layer 534 disposed over an upper emissive surface 533 of active matrix 532, a color filter 536, and cover glass 538.

According to various embodiments, the display active area 530 and underlying backplane 520 may be manufactured separately from, and then later bonded to, DDIC 510, which may simplify formation of the OLED active area, including formation of the active matrix 532, color filter 536, etc.

The DDIC 510 may be directly bonded to a back face of the backplane opposite to active matrix 532. In further embodiments, a chip-on-flex (COF) packaging technology may be used to integrate display panel 540 with DDIC 510, optionally via a data selector (i.e., multiplexer) array (not shown) to form OLED display device 500. As used herein, the terms “multiplexer” or “data selector” may, in some examples, refer to a device adapted to combine or select from among plural analog or digital input signals, which are transmitted to a single output. Multiplexers may be used to increase the amount of data that can be communicated within a certain amount of space, time, and bandwidth.

As used herein, “chip-on-flex” (COF) may, in some examples, refer to an assembly technology where a microchip or die, such as an OLED chip, is directly mounted on and electrically connected to a flexible circuit, such as a direct driver circuit. In a COF assembly, the microchip may avoid some of the traditional assembly steps used for individual IC packaging. This may simplify the overall processes of design and manufacture while improving performance and yield.

In accordance with certain embodiments, assembly of the COF may include attaching a die to a flexible substrate, electrically connecting the chip to the flex circuit, and encapsulating the chip and wires, e.g., using an epoxy resin to provide environmental protection. In some embodiments, the adhesive (not shown) used to bond the chip to the flex substrate may be thermally conductive or thermally insulating. In some embodiments, ultrasonic or thermosonic wire bonding techniques may be used to electrically connect the chip to the flex substrate.

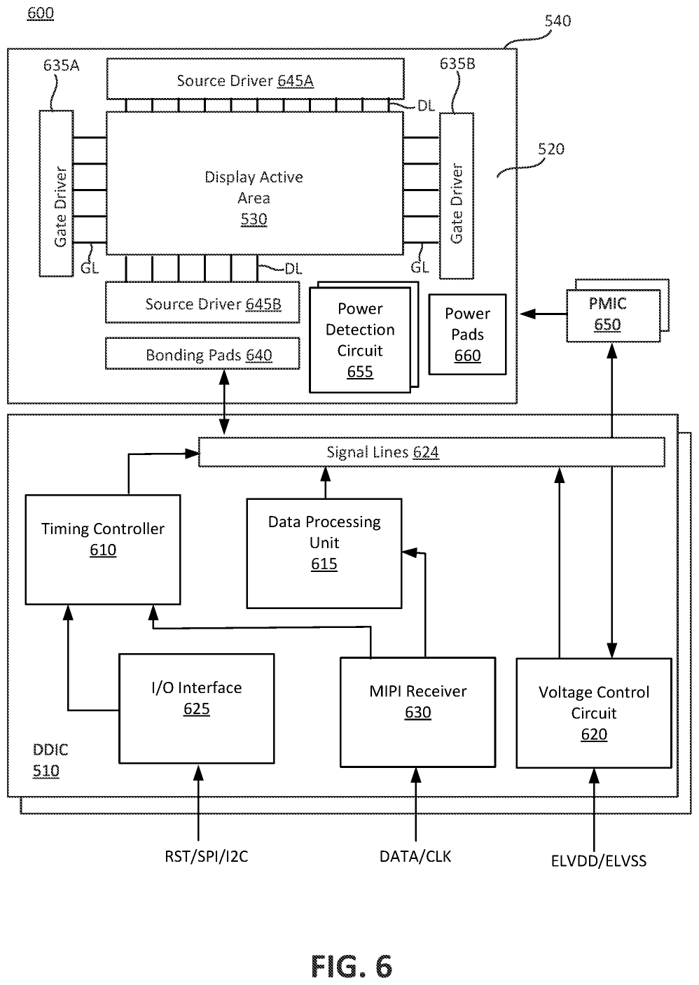

FIG. 6 is a schematic view of an OLED display device 600 according to some embodiments. The OLED display device 600 may include, among other components, one or more DDICs 510, one or more power management integrated circuits (PMICs) 650, and the display panel 540. The display panel 540 includes a display active area 530 that displays images according to timing signals and data signals from the one or more DDICs 510. The display panel 540 includes the display active area 530, bonding pads 640, power detection circuit 655, power pads 660, gate drivers 635A, 635B (collectively referred to as “gate drivers 635”), and source drivers 645A, 645B (collectively referred to as “source drivers 645”) disposed on the backplane 520. Each DDIC 510 may include a timing controller 610, a data processing unit 615, a voltage control circuit 620, an input/output (I/O) interface 625, a mobile industry processor interface (MIPI) receiver 630, and signal lines 624. In other embodiments, one or more components of the DDIC 510 may be disposed in the display panel 540. When there are multiple DDICs 510 in the OLED display device 600, each DDIC 510 may operate a different subset of the pixels in the display panel The DDICs 510 may operate in a parallel structure or in a master-slave structure. The display panel 540 is powered by the PMICs 650 according to power control signals from the DDICs 510. Each PMIC 650 may be an integrated circuit including one or more voltage regulators that provide supply voltages (e.g., ELVDD, ELVSS, AVDD) to the display panel 540. In some embodiments, the PMIC 650 may be incorporated into display panel 540 or the DDIC 510. The structure of the OLED display device 600 illustrated in FIG. 6 is merely an example, and components in the DDIC 510, the PMIC 650, and the display panel 540 may be interchangeable (e.g., the voltage control circuit 620 may be in the PMIC 650 instead of the DDIC 510).

The timing controller 610 generates timing control signals for the gate driver 635, the source drivers 645, and other components in the display panel 540. The timing controller 610 receives external signals via the I/O interface 625 and the MIPI receiver 630 and processes the external signals to generate the timing control signals. The timing control signals may include a clock, a vertical synchronization signal, a horizontal synchronization signal, and a start pulse. However, timing control signals provided from the timing controller 610 according to embodiments of the present disclosure are not limited thereto.

The data processing unit 615 receives image data DATA from the MIPI receiver 630 and converts the data format of the image data DATA to generate data signals input to the source drivers 645 for displaying images in the display active area 530.

The I/O interface 625 is a circuit that receives control signals from other sources and sends operation signals to the timing controller 610. The control signals may include a reset signal RST to reset the display panel 540 and signals according to serial peripheral interface (SPI) or inter-integrated circuit (I2C) protocols for digital data transfer. Based on the received control signals, the I/O interface 625 may process commands from a system on a chip (SoC), a central processing unit (CPU), or other system control chip.

The MIPI receiver 630 may be a MIPI display serial interface (DSI), which may include a high-speed packet-based interface for delivering video data to the pixels in the display active area 530. The MIPI receiver 630 may receive image data DATA and clock signals CLK and provide timing control signals to the timing controller 610 and image data DATA to the data processing unit 615.

The voltage control circuit 620 receives, via bonding pads 640 and signal lines 624, supply voltages sensed by the power detection circuits 655 at a plurality of locations along the power rails in the display panel 540 and generates power control signals to compensate for local voltage changes in the power rails. For each detected supply voltage at a corresponding location, the voltage control circuit 620 determines how much the detected supply voltage is lower or higher than the desired supply voltage. For example, if the desired voltage of the first supply voltage ELVDD is +5V, but the detected first supply voltage ELVDD at a first point along a segment of power rail is +4.6V, the voltage control circuit 620 generates power control signals to cause the PMIC 650 to increase the voltage level of the first supply voltage ELVDD output to a power pad 660 connected to the segment of power rail. The power control signals provided to the PMICs 650 may represent levels of increase or decrease in the supply voltages to be output (e.g., increase the output for the first supply voltage ELVDD to +5.4V). The power control signals are transmitted to the PMICs 650 via the signal lines 624. The voltage control circuit 620 may provide adjusted power control signals to the PMICs 650 once per frame or one per a predetermined number of frames (e.g., 3 frames).

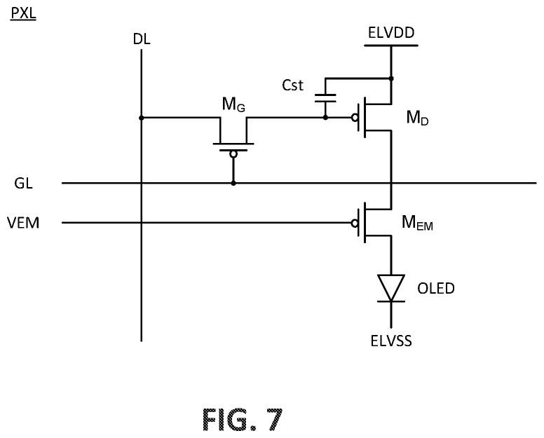

The display active area 530 includes a plurality of pixels arranged into rows and columns. Each pixel is connected to a gate line GL and a data line DL and driven to emit light according to a data signal received through the connected data line DL when the connected gate line GL provides a gate-on signal to the pixel. An example pixel structure is described with respect to FIG. 7.

FIG. 7 is a circuit diagram of an OLED pixel PXL, according to some embodiments. The pixel PXL includes a driving transistor M_{D} that is configured to generate a current proportional to a voltage stored by the storage capacitor Cst for driving the OLED. The OLED then generates light that is proportional to an amount of current provided by the driving transistor M_{D}. The OLED is connected to a first supply voltage ELVDD and a second supply voltage ELVSS. The first supply voltage ELVDD and the second supply voltage ELVSS are provided by power rails that are disposed throughout the display panel 540. Since the brightness of the pixel is proportional to the current being provided to the OLED, the amount of power consumed by the OLED is also proportional to the desired brightness of the OLED. That is, a display device 600 implemented using OLEDs consumes more power when displaying a brighter image by drawing more current compared to displaying a relatively darker image.

A gate transistor M_{G} controls a connection between a gate terminal of the driving transistor M_{D} and a data line DL. When a gate line GL provides a gate-on signal, the gate transistor M_{G} turns on, connecting the gate terminal of the driving transistor M_{D} to the data line DL and charging the storage capacitor Cst based on a voltage value of a data signal provided at the data line DL. When the gate line GL provides a gate-off signal, the gate transistor M_{G} is turned off, disconnecting the gate terminal of the driving transistor M_{G} from the data line DL. The emission transistor M_{EM} controls a connection between the driving transistor M_{D} and the OLED. When the emission signal VEM is asserted, the emission transistor M_{EM} turns on, connecting the driving transistor M_{D} to the OLED. When the driving transistor M_{D} is connected to the OLED, the OLED is turned on. In some embodiments, the data line DL is shared by a set of pixels disposed in a same column of the display area 240. Moreover, the gate line GL is shared by a set of pixels disposed in a same row of the active display area 530.

The pixel PXL may be one of a set of pixels in a section of the display active area 530 (e.g., upper left quadrant, lower half). For each pixel PXL in the set, a first terminal of the driving transistor M_{D} is connected to a segment of a first power rail that provides the first supply voltage ELVDD and a second terminal of the driving transistor is connected to a first terminal of the emission transistor M_{EM}. A second terminal of the emission transistor M_{EM} is connected to a segment of a second power rail that provides the second supply voltage ELVSS. Each of the segment of the first power rail and the segment of the second power rail is connected to at least one power pad 660 that receives the corresponding supply voltage from the PMIC 650. Depending on the change in local voltage along the segments of power rails during a frame, the PMICs 650 adjust the first supply voltage ELVDD and/or the second supply voltage ELVSS provided to the at least one power pad 660 for a subsequent frame. The structure of pixel in FIG. 7 is merely an example, and pixels of various other structure may also be used instead.

Referring back to FIG. 6, the backplane 520 may include conductive traces for electrically connecting the pixels in the display active area 530, the gate driver 635, the source drivers 645, the bonding pads 640, the power detection circuit 655, and the power pads 660. The bonding pads 640 are conductive regions on the backplane 520 that are electrically coupled to the signal lines 624 of the DDIC 510 to receive timing control signals from the timing controller 610 and data signals from the data processing unit 615. The bonding pads 640 are connected to the source drivers 645 and the gate driver 635 via the conductive traces in the backplane 520. In the embodiment illustrated in FIG. 6, the DDIC 510 generates data signals and timing control signals and transmits the signals to the bonding pads 640 of the display panel 540. However, in other embodiments, the timing controller 610 and/or the data processing unit 615 may be in the display panel 540 instead of the DDIC 510. When the timing controller 610 and/or the data processing unit 615 are on the display panel 540, there may be fewer bonding pads 640 since the data signals and timing control signals may be directly transmitted to the corresponding component through conductive traces in the display panel 540 without bonding pads 640. In addition to receiving signals from the DDIC 510, the bonding pads 640 may be used to transmit local supply voltages detected by the power detection circuit 655 from the display panel 540 to the voltage control circuit 620 of the DDIC 510.

The gate driver 635 is connected to a plurality of gate lines GL and provides gate-on signals to the plurality of gate lines GL at appropriate times. In some embodiments, each pixel in the display active area 530 is connected to a gate line. For a given pixel, when the pixel receives a gate-on signal via the corresponding gate line, the pixel can receive a data signal to emit light.

The source drivers 645 receives data signals from the data processing unit 615 and provides the data signals to the display active area 530 via data lines DL. Each of the source drivers 645 may be connected to a column of pixels via a data line DL.

The backplane 520 also includes power pads 660 which are conductive bonding pads dedicated to connect power rails in the backplane 520 to the PMICs 650. In some embodiments, the power pads 660 may be disposed at corners of the backplane 520. Each power pad 660 is connected to at least a segment of the power rails. The power rails carry supply voltages from the PMICs 650 to the pixels of the display active area 530.

The power detection circuits 655 sense local supply voltages at locations on the power rails and provide the sensed local supply voltages to the DDIC 510. Each power detection circuit 655 is connected to a location on the power rails and includes a sense amplifier and an analog-to-digital converter (ADC). The sense amplifier receives a local supply voltage at the location and generates a voltage signal that represents an amplified version of the received local supply voltage. The ADC receives the voltage signal representing the amplified version from the sense amplifier and generates a digital version of the amplified signal. The digital version of the amplified signal is provided to the DDIC 510 to be used by the voltage control circuit 620 to generate power control signals that compensate for the changes in the supply voltage at the location. The power detection circuit 655 may sense and provide voltage signals multiple times during a frame. In some embodiments, the power rails and the pixels in the display active area 530 are in a first voltage domain, and the power detection circuits 655 are in a second voltage domain at a lower voltage range than the first voltage domain. The OLEDs in the pixels use a higher voltage compared to the sense amplifier and the ADC in the power detection circuits 655.

The PMICs 650 provide supply voltages to the display panel 540. The PMICs 650 may provide a first supply voltage ELVDD and a second supply voltage ELVSS to the pixels in the display active area 530 and a third supply voltage AVDD to the source drivers 645. Each PMIC 650 includes one or more voltage regulators (e.g., low-dropout (LDO) regulators), each voltage regulator providing a supply voltage to one or more power pads 660 according to power control signals from the DDIC 510. The number of voltage regulators in the display device 600 matches the number of power detection circuits 655.

Each of the PMICs 650 is connected to a different one of the power pads 660. In some embodiments, the PMIC 650 adjusts voltage levels of the supply voltages once per frame of image. In other embodiments, the PMIC 650 adjusts voltage levels of the supply voltage once per a predetermined number of frames (e.g., 3 frames). The PMIC 650 adjusts the voltage level of the supply voltage in between frames instead of mid-frame because a change in the supply voltage during the frame may cause a change in the image being displayed, which may be visibly noticeable to a user.

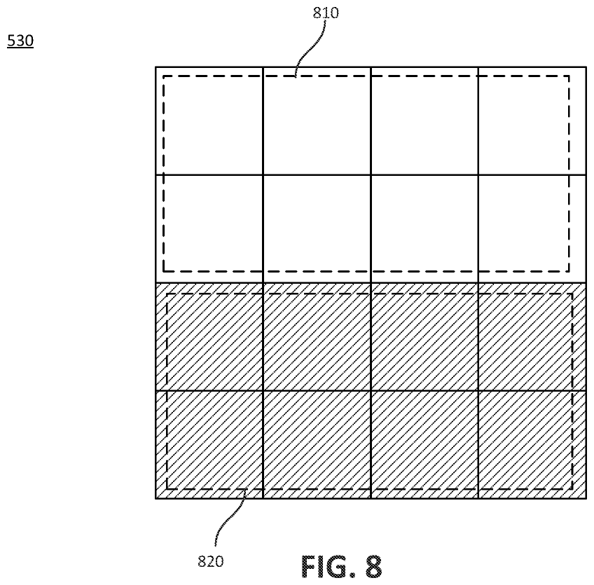

FIG. 8 depicts an example image displayed by an OLED display device 600, according to some embodiments. During a given frame, the pixels in a first section 810 of the display active area 530 displays a bright image while the pixels in a second section 820 displays a dark image. To display the bright image, the first section 810 draws more current compared to the second section 820. As a result, the local supply voltage along a first segment of the power rail connected to the first section 810 may be lower than a predetermined threshold of the desired supply voltage whereas the local supply voltage along a second segment of the power rail connected to the second section 820 is within a predetermined threshold of the desired supply voltage. A first power detection circuits 655 detects the local supply voltage at the first segment and provide the detected local supply voltage to the voltage control circuit 620 in the DDIC 510. To compensate for the drop in the supply voltage at the first segment, the voltage control circuit 620 generates updated power control signals to cause the supply voltage output to the first segment to be at a higher level during a subsequent frame. In contrast, because the local supply voltage along the second segment is within the predetermined threshold, the supply voltage output to the second segment may not be changed during the subsequent frame.

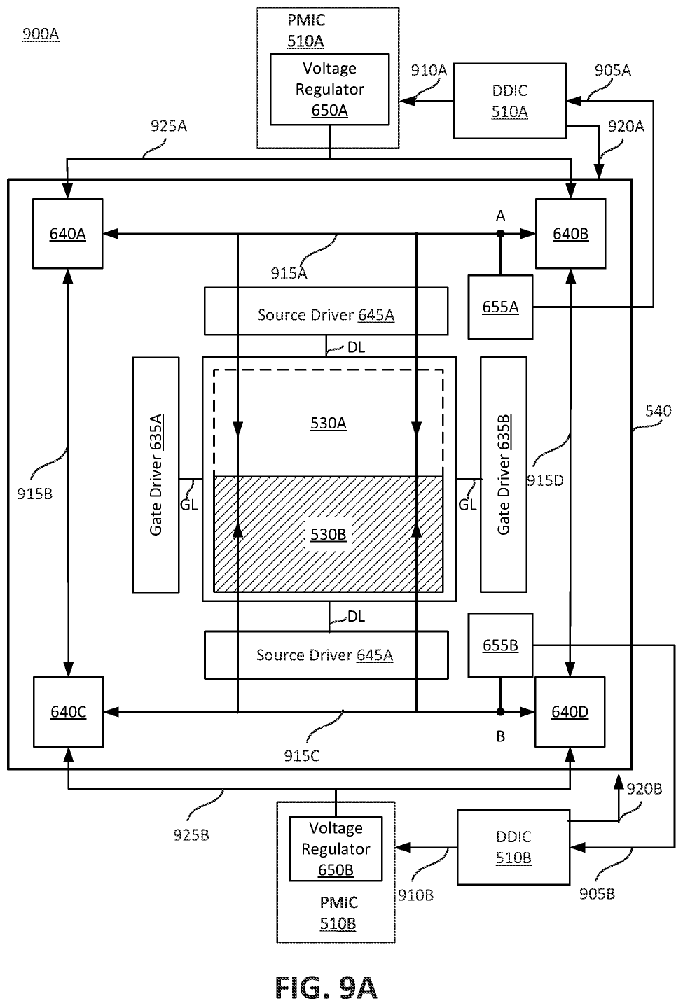

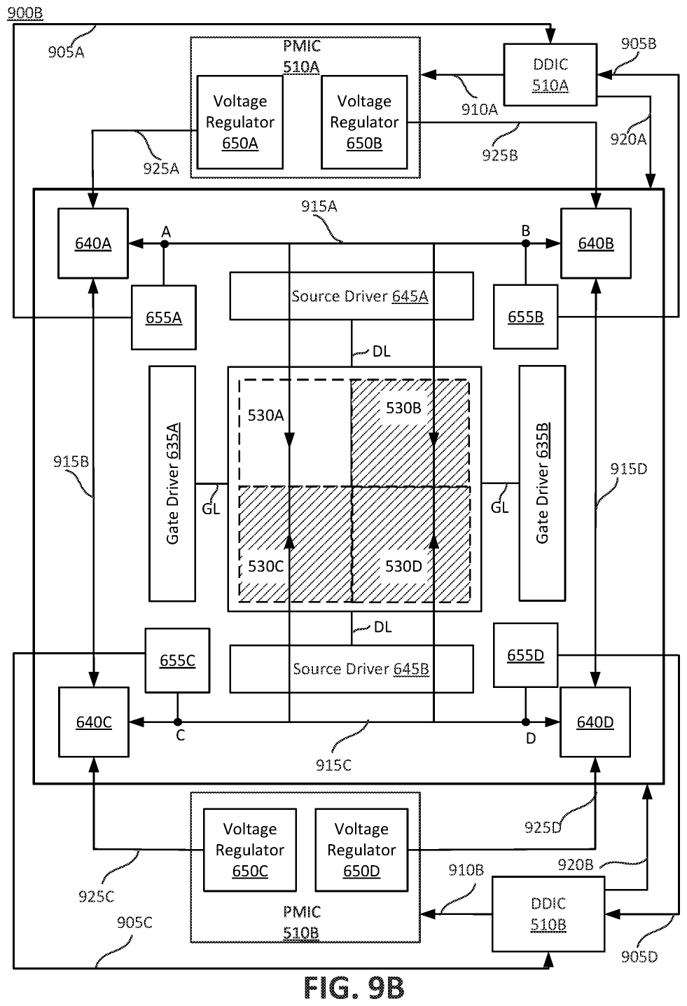

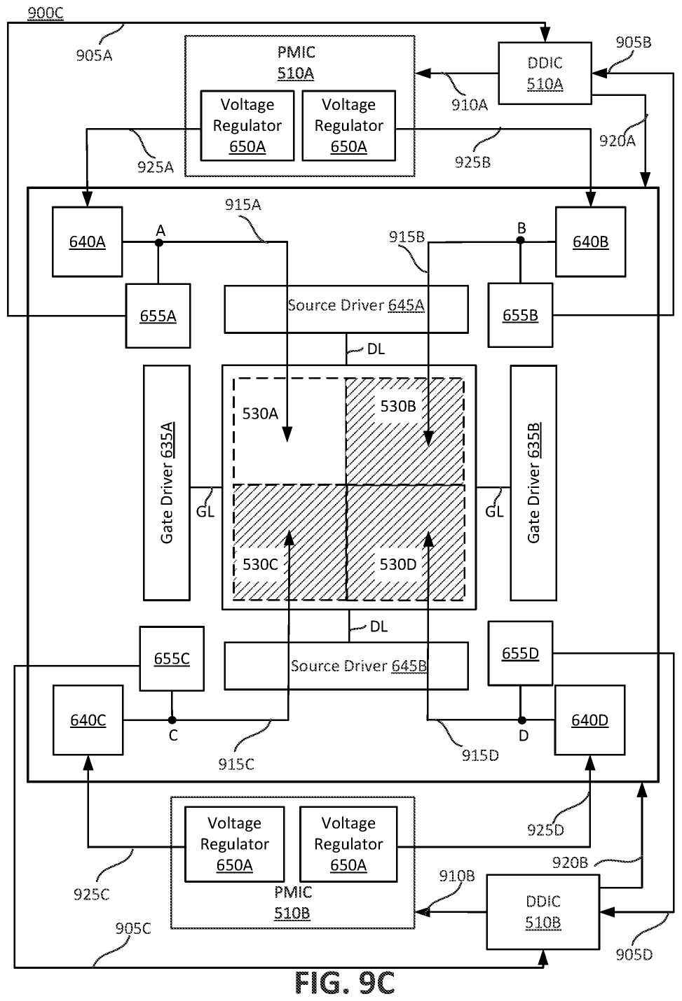

FIG. 9A illustrates a schematic view of supply voltage compensation of an OLED display device 600 that has a first layout 900A. In the first layout 900A, the OLED display device 600 includes a first PMIC 510A that receives power control signals 910A from a first DDIC 510A and a second PMIC 510B that receives power control signals 910B from a second DDIC 510B. In some embodiments, the first DDIC 510A operates a first section of the display active area 530A (e.g., upper half), and the second DDIC 510B operates a second section of the display active area 530B (e.g., lower half). In other embodiments, the first DDIC 510A operates odd numbered rows of pixels in the display active area 530, and the second DDIC 510 operates even numbered rows of pixels, or vice versa. The first PMIC 510A includes a first voltage regulator 650A that provides supply voltages to a first power pad 640A and a second power pad 640B. The second PMIC 510B includes a second voltage regulator 650B that provides supply voltages to a third power pad 640C and a fourth power pad 640D.

The first power pad 640A and the second power pad 640B are connected by a first segment of power rail 915A, the first power pad 640A and the third power pad 640C are connected by a second segment of power rail 915B, the third power pad 640C and the fourth power pad 640D are connected by a third segment of power rail 915C, and the second power pad 640D and the fourth power pad 640D are connected by a fourth segment of power rail 915D. In the first layout 900A, the power pads 640 are located at corners of the display panel 540, but the power pads 640 may be located elsewhere on the display panel 640. The segments of power rail 915 are configured to supply a first supply voltage ELVDD to pixels in the display active area 530. Although not illustrated, the display device 600 may include additional power pads 640, PMICs 510, power detection circuits 655, and power rails 915 to provide a second supply voltage (e.g., ELVSS) to the display active area 530 or a third supply voltage (e.g., AVDD) to operate the source driver 645.

A first power detection circuit 655A is connected to the first segment of power rail 915A at location A. As illustrated in FIG. 9A, location A is near the second power pad 640B. However, in other embodiments, location A may be anywhere on the first segment of power rail 915A (e.g., at a midpoint of the first segment of power rail 915A such that it is equidistant to the first power pad 640A and the second power pad 640B). Similarly, a second power detection circuit 655B is connected to a third segment of power rail 915C at location B. Although location B is illustrated in FIG. 9A as being near the fourth power pad 640D in FIG. 9A, location B may be anywhere along the third segment of power rail 915C in other embodiments. In alternative embodiments, at least one of the first power detection circuit 655A and the second power detection circuit 655B may be connected to the second segment 915B or the fourth segment 915D.

During each frame of image displayed by the display active area 530, the first power detection circuit 655A and the second power detection circuit 655B detects the local voltages at location A and location B, respectively. The first power detection circuit 655A and the second power detection circuit 655B each includes a sense amplifier and an ADC. In the first power detection circuit 655A, the sense amplifier receives the local voltage at location A and generates a voltage signal that represents an amplified version of the received local voltage. Then, the ADC converts the voltage signal into a digital version and provides the digital voltage signal 905A to the first DDIC 510A. The voltage control circuit 620A of the first DDIC 510A receives the voltage signal 905A and determines whether the detected local voltage at location A is lower or higher than a predetermined threshold of the desired supply voltage for the first supply voltage ELVDD. The voltage control circuit 620A may determine a difference in voltage between the desired supply voltage and the detected local voltage and determine a level of increase or decrease in the supply voltage to be supplied to compensate for the difference. The level of increase or decrease may be greater when the difference is higher compared to the level of increase or decrease when the difference is lower. The levels of increase or decrease in supply voltage is represented in power control signals 910A that are sent to the first voltage regulator 650A. The first DDIC 510A also provides other signals 920A including timing signals and data signals for operating the display panel 540. According to the power control signals 910A, the first voltage regulator 650A updates the supply voltage 925A provided to the first power pad 640A and the second power pad 640B.

Similarly, the second power detection circuit 655B detects local voltage at location B and provides a voltage signal 905B representing the detected local voltage to the second DDIC 510B. The second DDIC 510B generates power control signals 910B to control a second voltage regulator 650B of the second PMIC 510B. The second voltage regulator 650B provides an updated supply voltage 925B to the third power pad 640C and the fourth power pad 640D based on the power control signals 910B.

In some embodiments, the first power detection circuit 655A and the second power detection circuit 655B sample local voltages at a rate higher than the frame rate. That is, the first DDIC 510A and the second DDIC 510B may receive multiple voltage signals 905A, 905B representing sampled local voltages during each frame. The first DDIC 510A and the second DDIC 510B may aggregate the multiple voltage signals 905A, 905B and generate power control signals 910A, 910B once per frame of image or once per a predetermined number of frames (e.g., every three frames). For example, the first DDIC 510A and the second DDIC 510B may determine averages of the voltage signals 905A, 905B over a frame or a plurality of frames, and use the averages to generate the power control signals 910A, 910B. In another example, the first DDIC 510A and the second DDIC 510B may use voltage signals 905A, 905B associated with the largest deviation from the desired supply voltage to generate the power control signals 910A, 910B. In some embodiments, the power control signals 910A, 910B may be generated based on external signals. For example, the DDIC 510A, 510B may receive external signals indicating that the image in the next frame is to change significantly. Based on these external signals, the power control signals 910A, 910B may be generated to compensate for the expected change in the next frame.

In the example frame illustrated in FIG. 9A, a first section 530A of the display active area 530 is driven to emit brighter light than a second section 530B of the display active area 530. The brighter light in the first section 530A may put a greater load on the first segment of power rail 915A that supplies the supply voltage 925A to power the pixels in the first section 530A compared to a load on the third segment of power rail 915C that supplies the supply voltage 925B to power the pixels in the second section 530B. Therefore, the local voltage detected at location A may be lower than the local voltage at location B. To compensate for the difference, the supply voltage 925A provided by the first voltage regulator 650A to the first power pad 640A and the second power pad 640B in a subsequent frame may be greater than the supply voltage 925B provided by the second voltage regulator 650B.

FIG. 9B illustrates a schematic view of supply voltage compensation of an OLED display device 600 that has a second layout 900B. In the second layout 900B, the first PMIC 510A includes a first voltage regulator 650A and a second voltage regulator 650B, and the second PMIC 510B includes a third voltage regulator 650C and a fourth voltage regulator 650D. Comparing the second layout 900B to the first layout 900A, each of the first PMIC 510A and the second PMIC 510B includes an additional voltage regulator. Each voltage regulator 650A, 650B, 650C, 650D outputs a supply voltage 925A, 925B, 925C, 925D to a corresponding power pad 640A, 640B, 640C, 640D.

A first power sensing circuit 655A connected to location A of the first segment 915A provides voltage signals 905A representing local voltages at location A to the first DDIC 510A, and a second power sensing circuit 655B connected to location B of the first segment 915B provides voltage signals 905B representing local voltages at location B to the first DDIC 510A. The supply voltage 925A provided to the first power pad 640A is based on the voltage signals 905A detected by the first power sensing circuit 655A, and the supply voltage 925B provided to the second power pad 640B is based on the voltage signals 905B detected by the second power sensing circuit 655B. A third power sensing circuit 655C connected to location C of the third segment 915C provides voltage signals 905C representing local voltages to the second DDIC 510B, and a fourth power sensing circuit 655D connected to location D of the third segment 915D provides voltage signals 905D representing local voltages to the second DDIC 510B. The supply voltage 925C provided to the third power pad 640C is based on the voltage signals 915C detected by the third power sensing circuit 655C, and the fourth supply voltage 925D provided to the fourth power pad 640D is based on the voltage signals 915D detected by the fourth power sensing circuit 655D.

In alternative embodiments, the display device 600 includes one DDIC 510 instead of two DDICs 510. The four power detection circuits 655A, 655B, 655C, 655D may provide detected voltage signals 905A, 905B, 905C, 905D to the one DDIC 510 that controls both of the first PMIC 510A and the second PMIC 510B. Having multiple DDICs 510 is advantageous for reducing latency and supporting higher refresh rate.

In the second layout 900B, there are four power pads 640A, 640B, 640C, 640D that are independently powered by voltage regulators 650A, 650B, 650C, 650D. As such, subsegments of the first segment 915A and the third segment 915C may be compensated differently. In the example frame illustrated in FIG. 9B, a first section 530A emits brighter light than a second section 530B, a third section 530C, and a fourth section 530D. Therefore, the local voltage detected at location A may be lower than local voltages at location B, location C, and location D. Even though location A and location B are both on the first segment 915A, the local voltage at location A may be lower than location B. To compensate, the first voltage regulator 650A may updates the supply voltage 925A applied to the first power pad 640A to be greater than the supply voltages 925B, 925C, 925D applied to the other three power pads 640B, 640C, 640D. Having additional power detection circuits 655 and additional voltage regulators 650 allow the second layout 900B to compensate the supply voltages more precisely for different sections of the display active area 530.

FIG. 9C illustrates a schematic view of supply voltage compensation of an OLED display device 600 that has a third layout 900C. Comparing the third layout 900C to the second layout 900B of FIG. 9B, the first segment of power rail 915A, the second segment of power rail 915B, the third segment of power rail 915C, and the fourth segment of power rail 915D are all disconnected from each other. That is, each of the power pads 640A, 640B, 640C, 640D is associated with a section of the display active area 530A, 530B, 530C, 530D that is driven independently. When the power pads 640A, 640B, 640C, 640D are connected as illustrated in FIGS. 9A and 9B, change in supply voltage applied to one power pad can cause a change in supply voltage at another power pad. An advantage of the power pads 640A, 640B, 640C, 640D being connected is that when one segment of power rail has a significant drop in voltage, current can be drawn from another segment of power rail. However, driving the sections of the display active area independently as illustrated in FIG. 9C, over driving in boundaries between adjacent sections can be prevented.

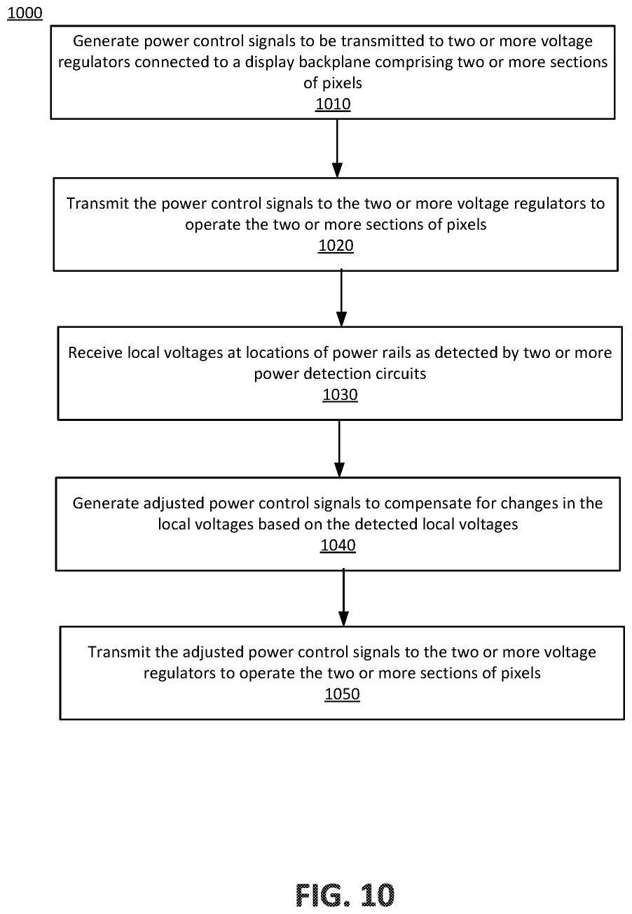

FIG. 10 is a flowchart 1000 illustrating supply voltage compensation of an OLED display device, according to some embodiments. An OLED display device generates 1010 power control signals to be transmitted to two or more voltage regulators connected to a display panel comprising two or more sections of pixels. Each of the two or more voltage regulators provides supply voltages to at least one of the two or more sections of pixels via power rails in the display panel. The OLED display device transmits 1020 the power control signals to the two or more voltage regulators to operate the two or more sections of pixels. The OLED display device receives 1030 local voltages at locations of power rails as detected by two or more power detection circuits. Based on the detected local voltages, the OLED display device generates 1040 adjusted power control signals to compensate for changes in the local voltages. The OLED display device transmits 1050 the adjusted power control signals to the two or more voltage regulators to operate the two or more sections of pixels.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

1. A display device, comprising:
a display panel comprising:
two or more sections of pixels,
power rails to provide supply voltages to operate the two or more sections of pixels, and
two or more power detection circuits connected to corresponding locations of the power rails to detect local voltages at the locations, the two or more power detection circuits comprising analog-to-digital converters to convert the detected local voltages to digital signals;
a voltage control circuit coupled to the display panel and at least a subset of the two or more voltage regulators, the voltage control circuit configured to:
receive the digital signals from the two or more power detection circuits,
determine levels of increase or decrease in the supply voltages to compensate for changes in the detected local voltages as indicated by the digital signals, and
generate power control signals for sending to the two or more voltage regulators, the power control signals representing the levels of increase or decrease in the supply voltages; and
two or more voltage regulators connected to the display panel, each of the two or more voltage regulators configured to provide a supply voltage to at least one of the two or more sections of the pixels, the two or more voltage regulators configured to generate the supply voltages to compensate for changes in the local voltages as detected by the two or more power detection circuits.

2. (canceled)

3. The display device of claim 1, wherein the voltage control circuit is included in a display driver integrated circuit (DDIC) that provides timing signals and data signals for operating the pixels to the display panel.

4. The display device of claim 3, further comprising another DDIC for operating a subset of the pixels, and wherein the DDIC functions as a slave of the other DDIC to operate another subset of the pixels.

5. The display device of claim 1, wherein the supply voltages are adjusted once per frame of image generated by the two or more sections of pixels.

6. The display device of claim 1, wherein the supply voltages are adjusted once per a predetermined number of frames of images generated by the two or more sections of pixels.

7. The display device of claim 1, wherein each of the power detection circuits further comprises:
a sense amplifier connected to one of the locations to receive a voltage at one of the locations, and configured to generate a voltage signal representing an amplified version of the received voltage for sending to an analog-to-digital converter.

8. The display device of claim 1, wherein the display panel comprises a plurality of power pads connected to at least a segment of the power rails, each of the two or more voltage regulators connected to a different one of the power pads to provide supply voltage.

9. The display device of claim 8, wherein a first segment of the power rails connected to one of power pads and powering one section of the pixels is disconnected from a second segment of the power rails connected another of the power pads and powering another section of the pixels.

10. The display device of claim 8, wherein the plurality of power pads are located at corners of the display panel.

11. The display device of claim 1, wherein the two or more voltage regulators are included in a same power management integrated circuit (PMIC).

12. The display device of claim 1, wherein a number of the voltage regulators is equal to a number of power detection circuits.

13. The display device of claim 1, wherein the power rails and the pixels are in a first voltage domain, and the power detection circuits are in a second voltage domain at a lower voltage range than the first voltage domain.

14. A method comprising:
generating power control signals to be transmitted to two or more voltage regulators connected to a display panel comprising two or more sections of pixels, each of the two or more voltage regulators configured to provide supply voltages to at least one of the two or more sections of pixels via power rails;
transmitting the power control signals to the two or more voltage regulators to operate the two or more sections of pixels;
receiving local voltages at locations of power rails as detected by two or more power detection circuits in the display panel;
converting the local voltages into digital signals by the two or more power detection circuits;
determining levels of increase or decrease in the digital changes in the local voltages as indicated by the digital signals;
generating power control signals for sending to the two or more voltage regulators, the power control signals representing the levels of increase or decrease in the supply voltages;
transmitting the generated power control signals to the two or more voltage regulators to operate the two or more sections of pixels.

15. (canceled)

16. The method of claim 14, wherein the power control signals are adjusted once per frame of image generated by the two or more sections of pixels.

17. The method of claim 14, wherein the power control signals are adjusted once per a predetermined number of frames of images generated by the two or more sections of pixels.

18. An electronic device comprising:
a display panel comprising:
two or more sections of pixels,
power rails to provide supply voltages to operate the two or more sections of pixels, and
two or more power detection circuits connected to corresponding locations of the power rails to detect local voltages at the locations, the two or more power detection circuits comprising analog-to-digital converters to convert the detected local voltages to digital signals;
a voltage control circuit coupled to the display panel and at least a subset of the two or more voltage regulators, the voltage control circuit configured to:
receive the digital signals from the two or more power detection circuits,
determine levels of increase or decrease in the supply voltages to compensate for changes in the detected local voltages as indicated by the digital signals, and
generate power control signals for sending to the two or more voltage regulators, the power control signals representing the levels of increase or decrease in the supply voltages; and
two or more voltage regulators connected to the display panel, each of the two or more voltage regulators configured to provide the supply voltage to at least one of the two or more sections of the pixels, the two or more voltage regulators configured to generate the supply voltages to compensate for changes in the local voltages as detected by the two or more power detection circuits.

19. (canceled)

20. The electronic device of claim 18, wherein the electronic device is a head-mounted display (HMD).
